(19) United States
(12) Patent Application Publication
(10) Pub. No.: US 2023/0351991 A1
(43) Pub. Date: Nov. 2, 2023

(54) KEYBOARD INSTRUMENT

(71) Applicant: CASIO COMPUTER CO., LTD., Tokyo (JP)

(72) Inventor: Hirokazu TANIGUCHI, Tokyo (JP)

(73) Assignee: CASIO COMPUTER CO., LTD., Tokyo (JP)

(21) Appl. No.: 18/133,251

(22) Filed: Apr. 11, 2023

(30) Foreign Application Priority Data
Apr. 28, 2022 (JP) 2022-074164

(51) Int. Cl. G10H 1/34

(52) U.S. Cl. CPC G10H 1/346; G10H 2220/221; G10H 2220/265

(57) ABSTRACT

A keyboard instrument includes a key including a key base including a top surface and a top surface support portion provided as to be suspended perpendicularly from a lower surface of the top surface, and an attachment configured to be disposed on a side surface of the top surface support portion. The top surface support portion includes a thick portion of a first thickness which is a thickness defined in a key alignment direction and a thin portion of a second thickness which is thinner than the first thickness in different positions along a longitudinal direction of the key base. A contact area with the attachment at the thick portion is larger than a contact area of the thin portion with the attachment.

### CROSS-REFERENCE TO RELATED APPLICATION

This patent application is based upon and claims the benefit of priority under 35 USC 119 of Japanese Patent Application No. 2022-074164 filed on Apr. 28, 2022, the entire disclosure of which, including the specification, claims, drawings and abstract, is incorporated herein by reference in its entirety.

### BACKGROUND

### Technical Field

The present disclosure relates to a keyboard instrument.

### Description of the Related Art

There have conventionally been proposed keyboard instruments which include keys in which an attachment made up of a pseudo-wood member or a wood member is attached to a key base. For example, Japanese Unexamined Patent Application Publication No. 2018-112763 (JP-A-2018-112763) discloses a configuration in which a plate-shaped wood member is provided corresponding to a broad portion of a key base where the width of a top plate is wide.

### SUMMARY

According to an aspect of the present disclosure, there is provided a keyboard instrument including a key including a key base including a top surface and a top surface support portion provided as to be suspended perpendicularly from a lower surface of the top surface, and an attachment configured to be disposed on a side surface of the top surface support portion, wherein the top surface support portion includes a thick portion of a first thickness which is a thickness defined in a key alignment direction and a thin portion of a second thickness which is thinner than the first thickness in different positions along a longitudinal direction of the key base, and wherein a contact area with the attachment at the thick portion is larger than a contact area of the thin portion with the attachment.

### BRIEF DESCRIPTION OF THE DRAWINGS

FIG. 1 is a perspective view showing a keyboard instrument according to an embodiment of the present disclosure;

FIG. 2 is a sectional view of the keyboard instrument according to the embodiment of the present disclosure taken along a line II-II in FIG. 1 with a white key and a black key shown in their side view;

FIG. 3 is an exploded perspective view of a white key of the keyboard instrument according to the embodiment of the present disclosure;

FIG. 4 is a left side view of a key base of the keyboard instrument according to the embodiment of the present disclosure;

FIG. 5 is a right side view of the key base of the keyboard instrument according to the embodiment of the present disclosure;

FIG. 6 is a perspective view of a white key of the keyboard instrument according to the embodiment of the present disclosure as viewed from below;

FIG. 7 is a sectional view of the white key of the keyboard instrument according to the embodiment of the present disclosure taken along a line VII-VII in FIG. 4; and

FIG. 8 is a sectional view of the white key of the keyboard instrument according to the embodiment of the present disclosure taken along a line VIII-VIII in FIG. 4.

### DESCRIPTION OF THE EMBODIMENT

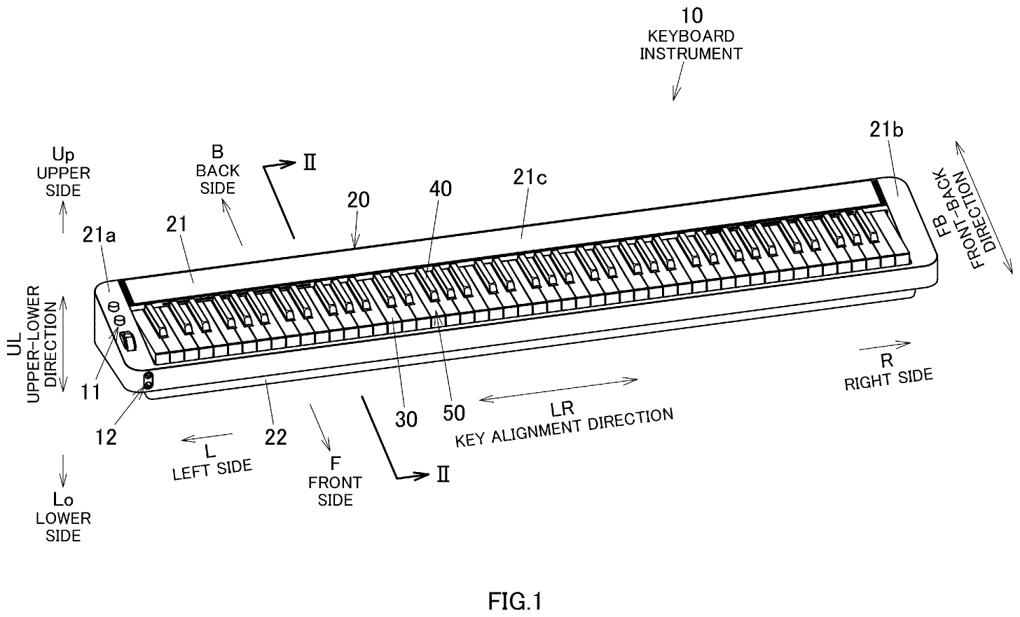

Hereinafter, an embodiment of the present disclosure will be described based on drawings. A keyboard instrument 10 shown in FIG. 1 includes a full-scale (88-note) keyboard 50 including plural white keys 30 and plural black keys 40, which make up a large number of keys or 88 keys of the keyboard 50, and a case 20. In the following description, a front to the keys in the keyboard 50 in a front-back direction FB is referred to as a front side F, and a rear or back to the keys in the keyboard 50 in the front-back direction FB is referred to as a back side B. When facing the keyboard 50 from the front side F, a left of the keyboard 50 is referred to as a left side L, and a right of the keyboard 50 is referred to as a right side R. In the keyboard 50, the keys are aligned in a left-right direction, which is referred to as a key alignment direction LR. When viewing the keyboard instrument 10 in an upper-lower direction UL thereof, an upper side is referred to as an upper side Up, and a lower side is referred to as a lower side Lo. In the present embodiment, while the keyboard instrument 10 is described as an electronic piano, the present disclosure may be applied to any other keyboard instruments as long as they are a musical instrument configured to sound notes in response to key press-down operations by a player (a user).

The case 20 has substantially a rectangular plate shape in which a longitudinal direction follows the left-right direction. The case 20 is divided into an upper case 21 and a lower case 22. The upper case 21 and the lower case 22 are each formed from a resin material. A circuit board, a battery functioning as a power supply, and the like are accommodated inside the case 20. A control section 11 including knobs or buttons and a rotary dial for volume control and various types of settings is provided on a left upper surface 21a of the upper case 21. In addition, an earphone jack 12 is provided in a left front surface of the upper case 21.

The upper surface 21a of the upper case 21 which lies adjacent to the keyboard 50 at a left side of the upper case 21 and an upper surface 21b of the upper case 21 which lies adjacent to the keyboard 50 at a right side of the upper case 21 are both formed into an inclined surface which inclines obliquely downwards from a back side towards a front side of the upper case 21. In addition, an upper surface 21c, which is provided at a central upper portion of the upper case 21 in such a manner as to be long in the left-right direction, is also formed into an inclined surface which inclines similarly. Although not shown, a hole portion is provided in a back surface of the upper case 21 for a speaker installed in the case 20.

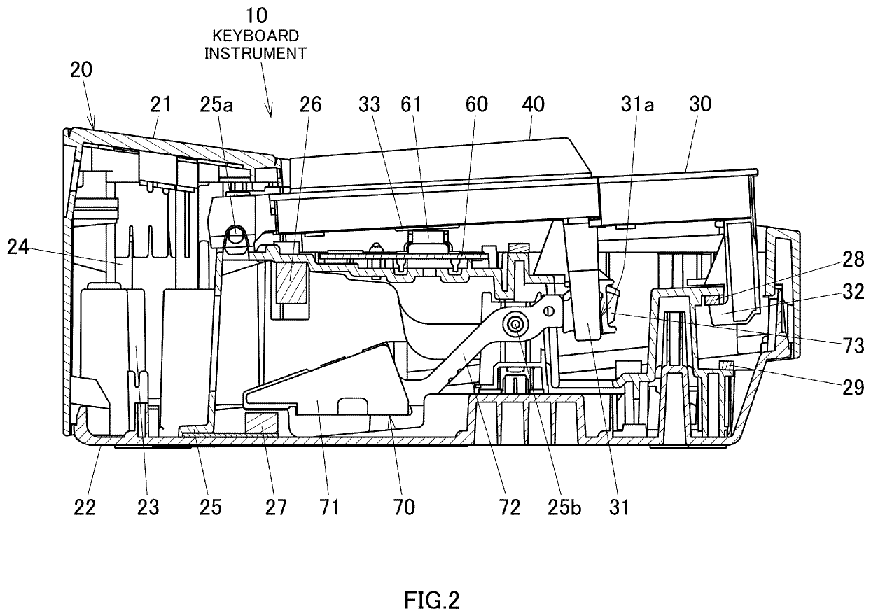

As shown in FIG. 2, the upper case 21 and the lower case 22 are assembled together into the case 20 by, for example, thread joining together a lower boss portion 23 set upright upwards from the lower case 22 and an upper boss portion 24 set upright downwards from the upper case 21 with a bolt. An inner case 25 is provided inside the case 20. The inner case 25 is formed long in the key alignment direction LR, and in a sectional view in FIG. 2, the inner case 25 has substantially an angular U-shaped section in which an open side is oriented towards the lower side Lo. A circuit board 60 is provided on an upper surface of the inner case 25. Plural switches 61 are provided on the circuit board 60 in such a manner as to correspond in position to the plural white keys 30 and black keys 40. On each of the white keys 30 and the black keys 40, a switch pressing portion 33 is provided in a position which corresponds to the switch 61 (in FIG. 2, only a switch pressing portion 33 for the white key 30 is shown, and no switch pressing portion for the black key 40 is shown).

A support shaft 25a for supporting each white key 30 and each black key 40 rotatably is provided corresponding to each white key 30 and each black key 40 at the back of the inner case 25. A hammer member 70 is provided corresponding to each white key 30 and each black key 40 inside the inner case 25. The hammer member 70 includes a weight portion 71 provided at a back side B thereof. An arm portion 72 extends from the weight portion 71 towards the front side F and is supported rotatably by a support shaft 25b provided inside the inner case 25. A hammer cap 73 is provided at a distal end of the arm portion 72 so as to be brought into engagement with a hammer pressing portion 31 which extends from each white key 30 and each black key 40 towards the lower side Lo (in FIG. 2, a hammer pressing portion 31 for the white key 30 is shown, and a hammer pressing member for the black key 40 is not shown). A hole portion 31a, with which the hammer cap 73 is configured to be brought into engagement, is provided in the hammer pressing member 31. Additionally, a hook-shaped restricting projection 32 is provided at a front end portion of each white key 30 in such a manner as to extend downwards towards the lower side Lo and then to project towards the back side B at a distal end portion thereof.

By taking one of the white keys 30 as an example, operations of the white key 30 and the hammer member 70 will be described. When the white key 30 is pressed down, the hammer pressing member 31 of the relevant white key 30 presses down the corresponding hammer cap 73. Then, the weight portion 71, which is provided opposite to the hammer cap 72 across the support shaft 25b, is raised. As a result, the player (the user) can strike the key while feeling a sensation of certain heaviness similar to what he or she feels when playing a real piano. Then, the weight portion 71 so raised is brought into abutment with an upper cushion 26 for the hammer 70, which is provided inside the inner case 25.

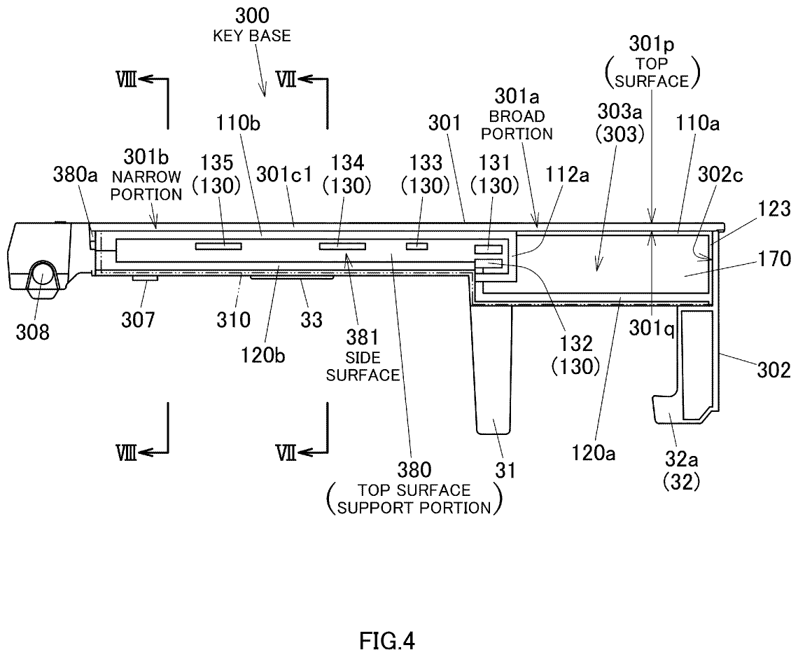

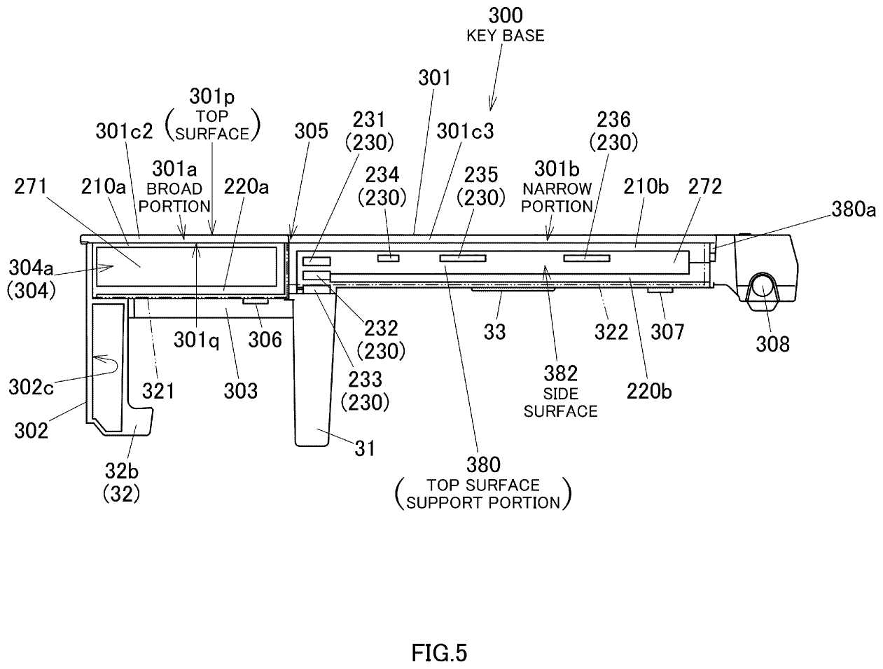

On the other hand, the restricting projection 32 is pushed down as a result of the white key 30 being pressed down and is then brought into abutment with a lower cushion 29 which is provided corresponding to the restricting projection 32. In addition, when the white key 30 is pressed down, the switch 61 is pressed down by the switch pressing portion 33 which is provided on the relevant white key 30, whereby a note corresponding to the white key 30 so pressed down is sounded. Then, when the player releases his or her hand from the white key 30, the weight portion 71 of the hammer member 70 is lowered to thereby be brought into abutment with a lower cushion 27, while a jaw-like portion of the restricting projection 32 is brought into abutment with an upper cushion 28, resulting in a state shown in FIG. 2. As shown in FIGS. 4 and 5, the restricting projection 32 is made up of a plate-shaped left restricting projection 32a and a plate-shaped right restricting projection 32b.

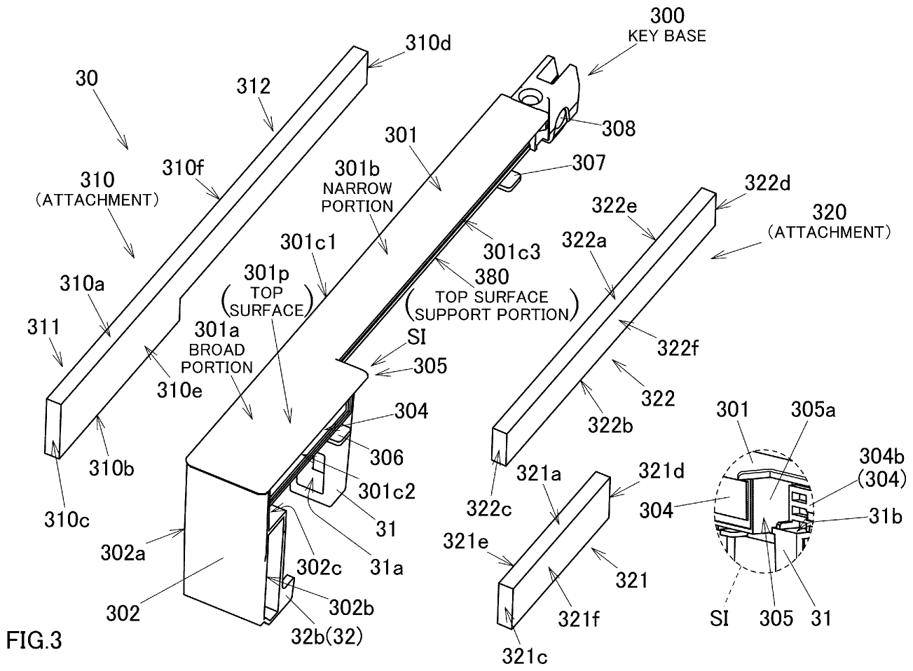

Next, the configuration of the white key 30 will be described. Hereinafter, by taking the white key 30 which is a key as a key C for a note C as an example, the configuration of the white key 30 will be described based on FIGS. 3 to 8. The white key 30 includes an attachment (a first member 310 and a second member 320) and a key base 300. The key base 300 is a wood member. The white key 30 is given an enhanced quality as a result of the attachment (the first member 310 and the second member 320) being attached to the key base 300.

The key base 300 includes the hammer pressing portion 31, the restricting projection 32, and the switch pressing portion 33, which have all been described before, provided thereon. A step portion 305 is provided in the key base 300 on a right side R thereof. A portion lying backwards of the step portion 305 is formed into a narrow portion which is configured to be disposed adjacent to the black key 40, while a portion lying forwards of the step portion 305 is formed into a broad portion including a key striking surface.

As shown in FIGS. 3 to 5, the key base 300 includes a top plate 301 having an upper surface 301p, which constitutes a top surface, and a lower surface 301q. The top plate 301 includes a broad portion 301a lying forwards of the step portion 305 and a narrow portion 301b lying backwards of the step portion 305. A front plate 302 is provided at a front end portion of the top plate 301 in such a manner as to extend downwards from the lower surface 301q. The front plate 302 is disposed with its plate surface oriented in the front-back direction FB and has the same width as that of the broad portion 301a of the top plate 301.

In addition, the key base 300 includes a left and right side plates (a left side plate 303, a right side plate 304) which are provided in such a manner as to correspond to the broad portion 301a of the top plate 301. The left side plate 303 and the right side plate 304 are both provided in such a manner as to be suspended perpendicularly from the lower surface 301q of the top surface (in other words, the lower surface 301q of the top plate 301). On the other hand, the key base 300 includes a longitudinal plate 380 (a top surface support portion), which is provided in such a manner as to correspond to the narrow portion 301b. In other words, the longitudinal plate 380 is suspended perpendicularly from the lower surface 301q of the top plate 301 (in other words, the lower surface 301q corresponding to the top surface) into a longitudinal plate shape and constitutes a portion which is defined from a back side of the step portion 305 to a back plate 380a, which will be described later. Of a left and right side surfaces 381, 382 of the longitudinal plate 380, the side surface 381 on the left side L is provided continuous to the side surface 303a of the left side plate 303 which corresponds in position to the broad portion 301a. On the other hand, the side surface 382 on the right side R connects with a side surface 304a of the right side plate 304 via a connecting plate 305a of the step portion 305. That is, the side surface 304a of the right side plate 304 does not continue to the side surface 382 of the longitudinal plate 380 on the right side R.

The first member 310 is formed into a plate shape having an external shape which corresponds to the side surface 303a of the left side plate 303 and the side surface 381 of the longitudinal plate 380 on the left side L on both of which the first member 310 is configured to be disposed. The first member 310 includes a front portion 311 and a back portion 312, and the front portion 311 and the back portion 312 are made to continue to each other. A length of the front portion 311 in the upper-lower direction UL is made longer than a length of the back portion 312 in the upper-lower direction UL. An upper surface 310a of the first member 310 is formed into a continuous surface, and a lower surface 310b thereof is formed into a vertically staggered configuration via a connecting portion between the front portion 311 and the back portion 312. The front portion 311 includes a portion which is configured to be disposed on the side surface 303a of the left side plate 303, and the back portion 312 includes a portion which is configured to be disposed on the side surface 381 of the longitudinal plate 380.

To describe this more specifically, as shown in FIGS. 3 and 4, the first member 310 is disposed on the left side plate 303 and the longitudinal plate 380 of the key base 300 with a front surface 310c brought into abutment with a back surface 302c of the front plate 302 of the key base 300, the upper surface 310a brought into abutment with the lower surface 301q of the top plate 301, and a side surface 310e brought into abutment with abutment surfaces 170 of the side surface 303a and the side surface 381 of the left side plate 303 and the longitudinal plate 380.

The second member 320 is formed into a plate shape having an external shape which corresponds to the right side plate 304 and the longitudinal plate 380 on both of which the second member 320 is configured to be disposed. The second member 320 includes a front second member 321 having a substantially rectangular plate shape which is elongated in the front-back direction FB and a back second member 322 having a substantially rectangular plate shape which is elongated in the front-back direction FB. A length of the front second member 321 in the upper-lower direction UL is made longer than a length of the back second member 322 in the upper-lower direction UL. The front second member 321 is disposed on the side surface 304a of the right side plate 304, and the back second member 322 is disposed on the side surface 382 of the longitudinal plate 380 on the right side R.

To describe this more specifically, as shown in FIGS. 3 and 5, the front second member 321 of the second member 320 is disposed on the right side plate 304 of the key base 300 with a front surface 321c brought into abutment with the back surface 302c of the front plate 302 of the key base 300, an upper surface 321a brought into abutment with the lower surface 301q of the top plate 301, and a side surface 321e brought into abutment with an abutment surface 271 of the side surface 304a of the right side plate 304.

Similarly, the back second member 322 of the second member 320 is disposed on the longitudinal plate 380 of the key base 300 with a front surface 322c brought into abutment with a back surface of the connecting plate 305a, an upper surface 322a brought into abutment with the lower surface 301q of the top plate 301, and a side surface 322e brought into abutment with an abutment surface 272 of the side surface 382 of the longitudinal plate 380.

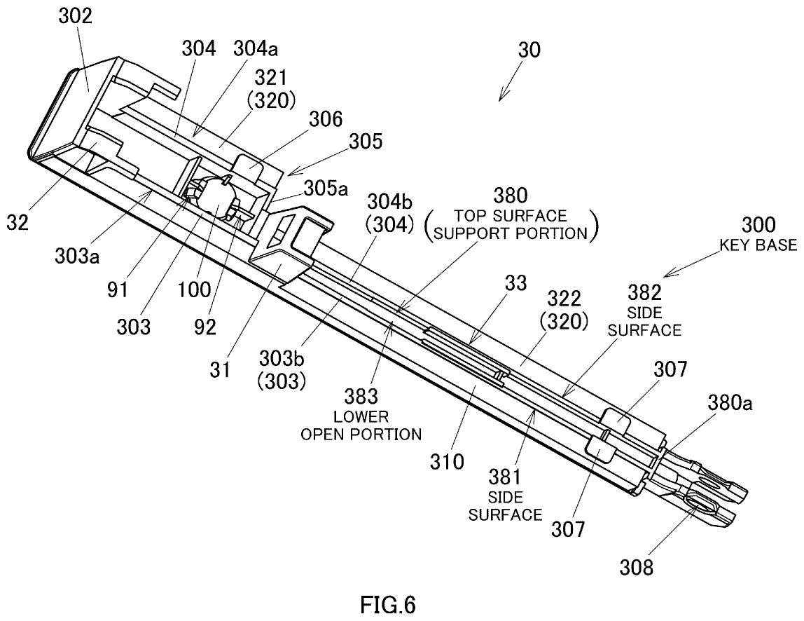

A back surface 310d of the first member 310 and a back surface 322d of the back second member 322 are not in abutment with a back plate 380a (also, refer to FIG. 6) which is erected in the left-right direction at a back end of the longitudinal plate 380 in such a manner as to face the back surfaces 310d, 322d, whereby a gap is provided therebetween. In addition, a back surface 321d of the front second member 321 of the second member 320 is left open.

The side surface 303a of the left side plate 303, the side surface 304a of the right side plate 304, and the side surfaces 381, 382 of the longitudinal plate 380 are provided in such positions that the relevant side surfaces are substantially level with side edges 301c1, 301c2, 301c3 of the top plate 301 on the left side L, an outer side surface 310f of the first member 310, an outer side surface 321f of the front second member 321, and an outer side surface 322f of the back second member 322.

As shown in FIG. 4, the side surface 303a of the left side plate 303 and the side surface 381 of the longitudinal plate 380 include, respectively, a first groove portion 110a and a first groove portion 110b, which are recessed groove portions provided along the lower surface 301q of the top plate 301, and a second groove portion 120a and a second groove portion 120b, which are provided, respectively, in the side surface 303a of the left side plate 303 and the side surface 381 of the longitudinal plate 380 in positions lying near lower edges of the relevant side surfaces. The first groove portions 110a, 110b and the second groove portions 120a, 120b are formed to depths and widths which are different from one another. The first groove portion 110a and the second groove portion 120a are connected to each other at front end portions thereof by a recessed groove, and the first groove portion 110b and the second groove portion 120b are connected to each other at back end portions thereof by a recessed groove.

As shown in FIG. 5, the side surface 304a of the right side plate 304 and the side surface 382 of the longitudinal plate 380 include, respectively, a first groove portion 210a and a first groove portion 210b, which are recessed groove portions provided along the lower surface 301q of the top plate 301, and a second groove portion 220a and a second groove portion 220b, which are provided, respectively, in the side surface 304a of the right side plate 304 and the side surface 382 of the longitudinal plate 380 in positions lying near lower edges of the relevant side surfaces. The first groove portion 210a and the second groove portion 220a which are provided on the side surface 304a of the right side plate 304 are connected to each other at front and back end portions thereof by recessed connecting grooves to thereby define a substantially rectangular ring-like shape. The first groove portion 110b and the second groove portion 220b which are provided on the side surface 382 of the longitudinal plate 380 are connected to each other at back end portions thereof by a recessed groove.

The first groove portions 110a, 110b, 210a, 210b and the second groove portions 120a, 120b, 220a, 220b constitute groove portions into which an excessive adhesive can retreat. That is, excessive portions of an adhesive resulting when the first member 310 and the second member 320 are attached to the abutment surfaces 170, 271, 272 which are provided on the side surface 303a of the left side plate 303, the side surface 381 of the longitudinal plate 380, the side surface 304a of the right side plate 304, and the side plate 382 of the longitudinal plate 380 with the adhesive flow into the first groove portions 110a, 110b, 210a, 210b and the second groove portions 120a, 120b, 220a, 220b for storage therein.

Plural substantially rectangular recessed portions 130 which are elongated in the front-back direction FB of the key are provided on the side surface 381 of the longitudinal plate 380 on the left side L. The recessed portions 130 include a first recessed portion 131 and a second recessed portion 132 which are provided in such a manner as to be aligned one above the other in a portion of the longitudinal plate 380 which lies at a front side F of the longitudinal plate 380, a third recessed portion 133 provided on a back side B of the first and second recessed portions 131, 132, a fourth recessed portion 134 provided on a back side B of the third recessed portion 133, and a fifth recessed portion 135 provided on a back side B of the fourth recessed portion 134. The recessed portions 130 are made to constitute thickness removing portions in the key base 300 which is made through injection molding.

Plural substantially rectangular recessed portions 230 which are elongated in the front-back direction FB are provided in the side surface 382 of the longitudinal plate 380 on the right side R. The recessed portions 230 include three recessed portions, that is, a first recessed portion 231, a second recessed portion 232, and a third recessed portion 233 which are provided in such a manner as to be aligned one above another on a front side F of the abutment surface 272, a fourth recessed portion 234 provided on a back side B of the first, second and third recessed portions 231, 232, 233, a fifth recessed portion 235 provided on a back side B of the fourth recessed portion 234, and a sixth recessed portion 236 provided on a back side B of the fifth recessed portion 235. The recessed portions 230 are made to constitute thickness removing portions in the key base 300 which is made through injection molding.

The third recessed portion 133 in the recessed portions 130 in the side surface 381 of the longitudinal plate 380 has the same position and size in the upper-lower direction UL and the front-back direction FB as those of the fourth recessed portion 234 in the recessed portions 230 in the side surface 382 of the longitudinal plate 380. Similarly, the fourth recessed portion 134 and the fifth recessed portion 235 are the same in position and size in the upper-lower direction UL and the front-back direction FB, and the fifth recessed portion 135 and the sixth recessed portion 236 are the same in position and size in the upper-lower direction UL and the front-back direction FB. That is, the recessed portions 130 and the recessed portions 230 include, respectively, the recessed portions 130 and the recessed portions 230 which are disposed so as to face each other. The third recessed portion 133 (the fourth recessed portion 234), the fourth recessed portion 134 (the fifth recessed portion 235), and the fifth recessed portion 135 (the sixth recessed portion 236) are provided intermittently on the same straight line in the front-back direction FB of the key. In addition, the third recessed portion 133 (the fourth recessed portion 234), the fourth recessed portion 134 (the fifth recessed portion 235), and the fifth recessed portion 135 (the sixth recessed portion 236) are made different from one another in length dimension in the front-back direction FB of the key and are made the same as one another in a height dimension in the upper-lower direction UL.

The abutment surface 170 between the recessed portions 130 and the second groove portion 120b and the abutment surface 272 between the recessed portions 230 and the second groove portion 220b are made into continuous surfaces each extending in a straight line along the same line in the front-back direction FB of the key. As a result, an adhesive with which the first member 310 and the second member 320 (the back second member 322) are attached respectively to the side surface 381 and the side surface 382 can be applied well to these continuous abutment surfaces 170, 272.

As shown in FIG. 6, the switch pressing portion 33, which has a plate shape, is provided on the longitudinal plate 380 in such a manner as to project from an inner surface of a lower open portion 383, which will be described later, towards the lower side Lo. A projection plate 306 is provided on a lower surface of the right side plate 304 in such a manner as to project to the right side R. Similarly, two projection plates 307 are provided on a lower surface of the longitudinal plate 380 at a portion lying on a back side B thereof in such a manner as to project in the key alignment direction LR. Even in the event that the first member 310 and the second member 320 fall down, the projection plates 306, 307 can receive the first member 310 and the second member 320.

A rotational hole portion 308, which is configured to be brought into rotatable engagement with the support shaft 25a in the inner case 25 inside the case 20, is provided in a back end portion of the key base 300 in such a manner as to penetrate the key base 300 in the key alignment direction LR. A counterweight 100, and a first rib 91 and a second rib 92 are provided on a lower surface of the broad portion 301a of top plate 301. The first rib 91 and the second rib 92 are provided at the front and the back of the counterweight 100 so as to fix the counterweight 100 in place therebetween.

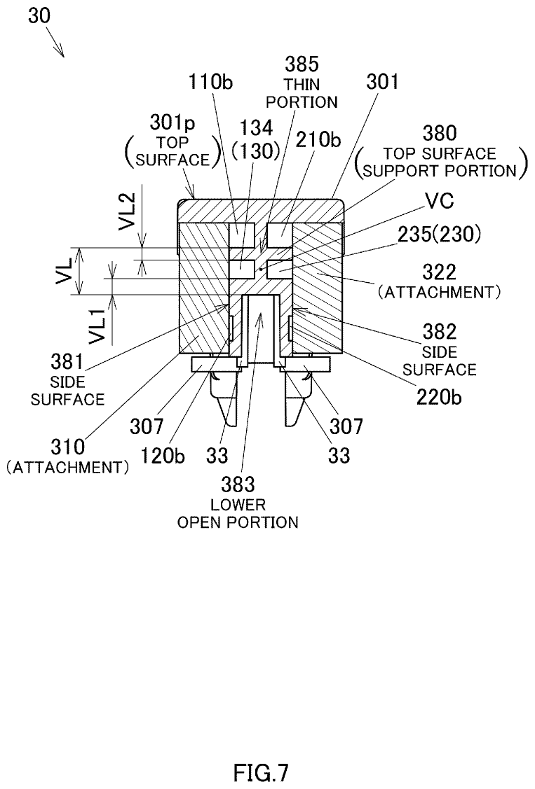

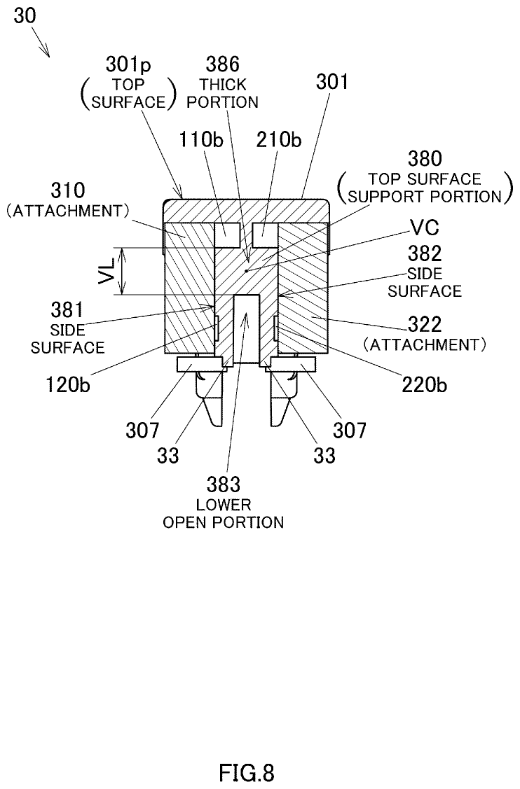

As shown in FIGS. 7 and 8, the longitudinal plate 380, which functions as the top surface support portion for supporting the upper surface 301p (the top surface) of the top plate 301, includes the lower open portion 383, which opens in a bifurcate fashion in a lower side thereof, and the side surfaces 381, 382. In the longitudinal plate 380 which is shown in section (a vertical section) in FIGS. 7 and 8, an area VL (a contact area) defined from lower edges of the first groove portions 110b, 210b to a starting point of the bifurcation of the lower open portion 383 is made into a thin portion 385 of a second thickness or a thick portion 386 of a first thickness. The thin portion 385 of the second thickness is thinner than the thick portion 386 of the first thickness in the key alignment direction LR.

As shown in FIG. 7, in the longitudinal plate 380, the area VL defined from the lower edges of the first groove portions 110b, 210b to the starting point of the bifurcation of the lower open portion 383 in a vertical section taken along a portion where the recessed portions 130, 230 (the fourth recessed portion 134, the fifth recessed portion 235) are provided is made into the thin portion 385. On the other hand, as shown in FIG. 8, in the longitudinal plate 380, an area VL defined from the lower edges of the first groove portions 110b, 120b to the starting point of the bifurcation of the lower open portion 383 in a vertical section taken along a portion where the recessed portions 130, 230 are not provided is made into the thick portion 386.

As has been described before, the recessed portions 130, 230 are provided intermittently in the front-back direction FB of the key in the side surfaces 381, 382 of the longitudinal plate 380. As a result, the longitudinal plate 380 includes the area where the thick portion 386 and the thin portion 385 are provided alternately in the front-back direction FB of the key. Further, the thick portion 386 and the thin portion 385 are provided alternately on the same line in the front-back direction FB of the key (for example, on a straight line in the front-back direction FB of the key which passes through a center VC of the area VL in the longitudinal plate 380 shown in FIGS. 7 and 8). In other words, the top surface support portion (the longitudinal plate 380) includes the thick portion 386 of the first thickness which is the thickness with respect to the key alignment direction LR and the thin portion 385 of the second thickness which is thinner than the first thickness in the different positions along the longitudinal direction (the front-back direction FB) of the key base 300.

As shown in FIG. 7, in a vertical sectional view, the contact area VL1, which constitutes an area where the side surfaces 381 382 are brought into contact, respectively, with the first member 310 and the back second member 322 at the thin portion 385, is an area (the area VL1+the area VL2) resulting from excluding the recessed portions 130, 230 (the fourth recessed portion 134, the fifth recessed portion 235) in the area VL (the area VL1+the area VL2<the area VL).

Similarly, as shown in FIG. 8, in a vertical sectional view, a contact area, which constitutes an area where the side surfaces 381, 382 are brought into contact, respectively, with the first member 310 and the back second member 322 at the thick portion 386, is made up of an overall range of the area VL.

The contact area at the thick portion 386 is larger than the contact area at the thin portion 385. That is, at the thin portion 385 where the recessed portions 130, 230 are provided, the contact area constituting the area where the side surfaces 381, 382 are brought into contact, respectively, with the first member 310 and the back second member 322 becomes smaller by the lengths of the recessed portions 130, 230 in the upper-lower direction UL.

For example, in the case that a long recessed portion is provided in each of the side surfaces 381, 382 of the longitudinal plate 380 along the front-back direction FB of the key so as to form a thickness removing portion in each of the side surfaces 381, 382, a thin portion 385 is provided long along the front-back direction FB of the key, whereby contact areas which are made up of vertical sections which are at right angles, respectively, to the side surfaces 381, 382 and where the side surfaces 381, 382 contact, respectively, the first member 310 and the back second member 322 become extremely small. Then, the surface areas of the abutment surfaces 170, 272 of the side surfaces 381, 382 which are brought into abutment, respectively, with the first member 310 and the back second member 322 become small, resulting, from time to time, in a case in which the first member 310 and the back second member 322 cannot properly be attached to the side surfaces 381, 382, respectively, due to an insufficient bonding force.

However, as in the configuration of the present embodiment, the recessed portions 130, 230 are provided intermittently, and the thick portion 386 and the thin portion 385 are provided alternately, whereby the contact areas which are made up of the vertical sectional surfaces which are at right angles to the side surfaces 381, 382 and where the side surfaces 381, 382 are brought into contact, respectively, with the first member 310 and the back second member 322 are increased by the thick portion 386, thereby making it possible to secure sufficiently the surface areas of the abutment surfaces 170, 272 where the first side member 310 and the back second member 322 are brought into contact, respectively, with the side surface 381 and the side surface 382, that is, the areas (the contact areas) where the first member 310 and the back second member 322 are bonded respectively to the side surface 381 and the side surface 382 with an adhesive.

In the present embodiment, while the description has been made on the key base 300 associated with the key C, the present disclosure can be equally carried out on key bases of the other keys A, B, D, E and F.

In JP-A-2018-112763 described before, as to the attachment made up of the wood member or the like, there may be a case in which a thick attachment is used depending upon an attachment target. Additionally, there may be a case in which such an attachment is desired to be attached not only to the side surface corresponding to the broad portion but also to the side surface corresponding to the narrow portion of the key base. In this case, the gap defined between the side plates including both the left and right side surfaces becomes narrow. Then, in the case that the key base is formed from a resin through injection molding, it may be difficult to make a mold including a thin core block which is thin enough to form such a narrowed gap which is configured to be defined between the two side plates. Additionally, both the side plates have to be extremely thin, and in this case, it may be difficult to form such a key base using injection molding. As a result, there is caused a concern about the provision of a good key base.

In contrast to this, with the present embodiment, the keyboard instrument 10 includes the keys which each include the top surface which is the upper surface 301p of the top plate 301, the key base 300 including the longitudinal plate 380 which is the top surface support portion provided in such a manner as to be suspended perpendicularly from the lower surface 301q of the top surface (the lower surface 301q corresponding to the top surface), and the attachments (the first member 310 and the second member 320) which are configured to be disposed on the side surfaces 381, 382 of the top surface support member (the longitudinal plate 380). Then, the top surface support portion (the longitudinal plate 380) includes the thick portion 386 of the first thickness which is the thickness defined in the key alignment direction LR and the thin portion 385 of the second thickness which is thinner than the first thickness in the different positions along the longitudinal direction of the key base 300, and the contact area (the overall range of the area VL) with the attachment at the thick portion 386 is larger than the contact area of the thin portion 385 with the attachment (the area of VL1+VL2).

As a result, the first member 310 and the second member 320 (the back second member 322) which are the attachments configured to be attached to the side surfaces 381, 382 with an adhesive or the like are made thin by the thin portions 385 while properly securing the surface areas where the first member 310 and the second member 320 (the back second member 322) are brought into contact with the side surfaces 381, 382, whereby the moldability of the key base 300 through injection molding can be improved. As a result, the keyboard instrument 10 can be provided which includes the key base 300 of a good quality to which the first member 310 and the second member 320 (the back second member 322) which are made up of the wood attachments are configured to be attached. In the present embodiment, while the top plate 301 and the longitudinal plate 380 are both formed into the plate shape, another form may be adopted in which the top plate 301 and the longitudinal plate 380 are formed into a block shape or the like.

The longitudinal plate 380, which is the top surface support portion, includes the lower open portion 383 which is opened in the lower side thereof, and the thick portions 386 and thin portions 385 are provided alternately on the same line in the front-back direction FB of the key in the lower side Lo of the top plate 301 (in other words, the lower side Lo of the top surface) and the upper side Up of the lower open portion 383. As a result, since the longitudinal plate 380 which is long in the straight line can be molded well, and further, the first member 310 and the second member 320 (the back second member 322) can be attached well to the longitudinal plate 380, the narrow portion 301b of the key base 300 can be given the good quality. In particular, although the first member 310 tends to warp easily since the first member 310 is long in the front-back direction FB of the key, a risk of the first member 310 which is made up of the wood member falling down due to the warp thereof can be reduced as a result of the portion having the large bonding surface area (the thick portion 386) appearing intermittently.

The thin portion 385 includes the thickness removing portions which are the recessed portions 130, 230 which are provided into the recessed shape from the side surfaces 381, 382. As a result, even with the longitudinal plate 380 which makes it difficult for the core block of the mold to enter from the lower side thereof, a mold can be configured which can mold the thin portion 385 easily by providing in the mold a core block for forming the recessed portions 130, 230 from the side surfaces 381, 382.

In addition, the recessed portions 130, 230, which are the thickness removing portions, are provided intermittently along the front-back direction FB of the key. As a result, it becomes easy to configure a mold for providing the thick portion 386 and the thin portion 385 alternately. In the present embodiment, the recessed portions 130, 230, which are the thickness removing portions, include the recessed portions having the different widths (lengths) in the longitudinal direction of the key. However, the widths (the lengths) of the recessed portions 130, 230, which are the thickness removing portions, may all be the same.

The recessed portions 130, 230, which are the thickness removing portions, are provided on the same line in the front-back direction FB of the key. As a result, the rectilinear area can be included in which the contact areas where the side surfaces 381, 382 contact, respectively, the first member 310 and the second member 320 (the back second member 322) continue, whereby the base member 300 can be provided which facilitates the application of the adhesive. In the present embodiment, the recessed portions 130, 230, which are the thickness removing portions, are almost the same in the width (the length) in the upper-lower direction UL. However, the recessed portions 130, 230, which are the thickness removing portions, do not always have to be the same in the width (the length) in the upper-lower direction UL.

The recessed portions 130, 230 are provided which constitute the plural thickness removing portions having the different lengths in the front-back direction FB of the key. As a result, the key base 300 can be provided in which the generation of a sink mark is prevented well by providing appropriate thickness removing portions which matches the cooling speed of the resin in the mold.

The first groove portions 110b, 210b, which are the recessed groove portions, are provided in the side surfaces 381, 382 on the lower side Lo of the top plate 301 (in other words, the lower side Lo of the top surface) and on the upper side Up of the thick portions 386 or the thin portions 385. As a result, the adhesive can be made to flow around into the top plate 301 while the excessive adhesive is being stored therein.

The key base 300 has the broad portion 301a where the width of the top plate 301a (in other words, the width of the top surface) is broad and the narrow portion 301b where the width of the top plate 301 (in other words, the width of the top surface) is narrow, and the longitudinal plate 380 is provided corresponding to the narrow portion 301b. As a result, even with the narrow portion 301b which is so thin and long as to be molded properly with much difficulty, the narrow portion 301b can be molded properly without any difficulty, whereby the keyboard instrument 10 can be provided which includes the key base 300 to which the first member 310 and the second member 320 (the back second member 322) are attached well.

While the embodiment of the present disclosure has been described heretofore, the embodiment is presented as the example, and hence, there is no intention to limit the scope of the present invention by the embodiment. The novel embodiment can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents.

What is claimed is:

1. a keyboard instrument comprising:
a key comprising:
a key base comprising a top surface and a top surface support portion provided as to be suspended perpendicularly from a lower surface of the top surface; and
an attachment configured to be disposed on a side surface of the top surface support portion,
wherein the top surface support portion comprises a thick portion of a first thickness which is a thickness defined in a key alignment direction and a thin portion of a second thickness which is thinner than the first thickness in different positions along a longitudinal direction of the key base, and
wherein a contact area with the attachment at the thick portion is larger than a contact area of the thin portion with the attachment.

2. The keyboard instrument according to claim 1,
wherein the top surface support portion comprises a lower open portion which is opened in a lower side thereof, and
wherein the thick portion and thin portion are provided alternately on a same line in a front-back direction of the key in a lower side of the top surface and an upper side of the lower open portion.

3. The keyboard instrument according to claim 1,
wherein the thin portion comprises a thickness removing portion which is provided into a recessed shape from the side surface.

4. The keyboard instrument according to claim 3,
wherein the thickness removing portion is provided intermittently along a front-back direction of the key.

5. The keyboard instrument according to claim 4,
wherein the thickness removing portion is provided on a same line in the front-back direction of the key.

6. The keyboard instrument according to claim 5,
wherein the thickness removing portion is provided plural, the plural thickness removing portions so provided having different lengths in the front-back direction of the key.

7. The keyboard instrument according to claim 6,
wherein the key base further comprising a recessed groove portion, which is provided in the front-back direction of the key, is provided in the side surface on a lower side of the top surface of the top surface support portion and on an upper side of the thick portion or the thin portion.

8. The keyboard instrument according to claim 1,
wherein the key base comprises a broad portion where a width of the top surface is broad and a narrow portion where the width of the top surface is narrow, and
wherein the top surface support portion is corresponding to the narrow portion.
